(19) United States
(12) Patent Application Publication
(10) Pub. No.: US 2025/0333065 A1
(43) Pub. Date: Oct. 30, 2025

(54) PREDICTION OF USAGE OF SMOKING PRODUCTS IN VEHICLES USING MACHINE LEARNING

(71) Applicant: HERE Global B.V., Eindhoven (NL)

(72) Inventors: Jérôme BEAUREPAIRE, Nantes (FR); Nicolas NEUBAUER, Berlin (DE)

(21) Appl. No.: 18/649,263

(22) Filed: Apr. 29, 2024

(51) Int. Cl. B60W 40/09; B60W 40/08

(52) U.S. Cl. CPC B60W 40/09; B60W 2040/0845

(57) ABSTRACT

An approach is provided for the prediction of the usage of smoking products in vehicles using machine learning. The approach, for example, involves obtaining, from at least one sensor, first smoking event data associated with a first smoking event on a first road link. The first smoking event is associated with the usage of at least one smoking product by a first user on the first road link. The approach further involves retrieving a first set of features including road link properties of the first road link and context information associated with the first smoking event on the first road link. The approach further involves training a machine learning (ML) model using the retrieved first set of features to determine an association between the retrieved first set of features and the first smoking event and storing the trained ML model.

### BACKGROUND

Smoking while driving poses a multifaceted challenge to road safety, as it introduces distractions that can lead to impaired driving performance and an elevated risk of accidents. One significant issue associated with smoking while driving is visual distraction. Generally, drivers engage in a search for a smoking product (say cigarettes) and lighters within the confines of their vehicle, thereby diverting their attention away from the road. This search introduces an unnecessary and potentially dangerous element, as drivers may visually scan the interior of the vehicle while driving, increasing the likelihood of accidents due to reduced focus on the traffic environment. Also, the act of searching for and lighting the cigarette introduces cognitive distraction, as the driver's mental resources are redirected from the primary task of driving the vehicle to a secondary task of finding the smoking product, optionally igniting it, and then smoking. This process of finding and igniting the smoking product requires concentration and focus, diverting attention from critical driving-related activities and impeding the driver's ability to make timely and informed decisions on the road. Furthermore, smoking while driving induces manual distraction, as drivers are compelled to manipulate smoking-related paraphernalia. Typically, lighting the cigarette requires both hands to be momentarily disengaged from the steering wheel, impairing the driver's ability to maintain control of the vehicle. Moreover, once the cigarette is lit, drivers often drive with one hand, posing a further risk to the stability of the vehicle. The need to expel ash introduces an additional manual distraction, as drivers must navigate the removal of ash without taking their eyes off the road.

Despite the well-known dangers associated with distracted driving, smoking remains a prevalent behavior on the roads, thereby necessitating innovative solutions to address this safety concern. As it is also widely recognized, smoking is also a recognized health hazard and an addiction. Innovative solutions that aid smokers in eliminating, or at least reducing, the smoking habit are necessary to support healthier living.

### SOME EXAMPLE EMBODIMENTS

According to one embodiment, a method for the prediction of the usage of smoking products in vehicles using machine learning is provided. The method comprises obtaining first smoking event data associated with a first smoking event on a first road link. The first smoking event data may be obtained from at least one sensor. The first smoking event may be associated with the usage of at least one smoking product by a first user on the first road link. The method may further include retrieving a first set of features including road link properties of the first road link and context information associated with the first smoking event on the first road link. The method may further include training a machine learning (ML) model using the retrieved first set of features to determine an association between the retrieved first set of features and the first smoking event. The method may further include storing the trained ML model.

According to another embodiment, a system for prediction of usage of smoking products in vehicles using machine learning is provided. The system comprises at least one processor configured to obtain first smoking event data associated with a first smoking event on a first road link. The first smoking event data may be obtained from at least one sensor. The first smoking event may be associated with the usage of at least one smoking product by a first user on the first road link. The system may further retrieve a first set of features including road link properties of the first road link and context information associated with the first smoking event on the first road link. The system may further train a machine learning (ML) model using the retrieved first set of features to determine an association between the retrieved first set of features and the first smoking event. The system may further store the trained ML model.

According to another embodiment, a non-transitory computer-readable medium carries one or more sequences of one or more instructions which, when executed by one or more processors, cause, at least in part, an apparatus to perform operations. The operations comprise obtaining first smoking event data associated with a first smoking event on a first road link. The first smoking event data may be obtained from at least one sensor. The first smoking event may be associated with the usage of at least one smoking product by a first user on the first road link. The operations further comprise retrieving a first set of features including road link properties of the first road link and context information associated with the first smoking event on the first road link. The operations further comprise training a machine learning (ML) model using the retrieved first set of features to determine an association between the retrieved first set of features and the first smoking event. The operations further comprise storing the trained ML model.

According to one embodiment, a method for prediction of usage of smoking products in vehicles using machine learning is provided. The method comprises retrieving a second set of features including road link properties of a second road link and context information associated with a second smoking event on the second road link. The first user is expected to travel on a first route that includes the second road link. The method may further include providing, as an input, the retrieved second set of features to the ML model. The method may further include predicting a second probability score associated with the usage of the at least one smoking product by the first user on the second road link based on an output of the ML model. The method may further include comparing the second probability score with a pre-determined threshold probability score. The method may further include determining, based on the comparison, a second route including at least a third road link of a set of road links. A destination of the second route is the same as the destination of the first route, and a third probability score associated with the usage of the at least one smoking product by the first user on the third road link is less than at least one of the pre-determined threshold probability score or the second probability score. The method may further include providing the determined second route for navigation via a user device associated with the first user.

According to another embodiment, a system for prediction of usage of smoking products in vehicles using machine learning is provided. The system comprises at least one processor configured to retrieve a second set of features including road link properties of a second road link and context information associated with a second smoking event on the second road link. The first user is expected to travel on a first route that includes the second road link. The system may further provide, as an input, the retrieved second set of features to the ML model. The system may further predict a second probability score associated with the usage of the at least one smoking product by the first user on the second road link based on an output of the ML model. The system may further compare the second probability score with a pre-determined threshold probability score. The system may further determine, based on the comparison, a second route including at least a third road link of a set of road links. A destination of the second route is the same as the destination of the first route, and a third probability score associated with the usage of the at least one smoking product by the first user on the third road link is less than at least one of the pre-determined threshold probability score or the second probability score. The system may further provide the determined second route for navigation via a user device associated with the first user.

According to another embodiment, a non-transitory computer-readable storage medium carries one or more sequences of one or more instructions which, when executed by one or more processors, cause, at least in part, an apparatus to perform operations. The operations comprise retrieving a second set of features including road link properties of a second road link and context information associated with a second smoking event on the second road link. The first user is expected to travel on a first route that includes the second road link. The operations further comprise providing, as an input, the retrieved second set of features to the ML model. The operations further comprise predicting a second probability score associated with the usage of the at least one smoking product by the first user on the second road link based on an output of the ML model. The operations further comprise comparing the second probability score with a pre-determined threshold probability score. The operations further comprise determining, based on the comparison, a second route including at least a third road link of a set of road links. A destination of the second route is the same as the destination of the first route, and a third probability score associated with the usage of the at least one smoking product by the first user on the third road link is less than at least one of the pre-determined threshold probability score or the second probability score. The operations further comprise providing the determined second route for navigation via a user device associated with the first user.

According to one embodiment, a method for prediction of usage of smoking products in vehicles using machine learning is provided. The method comprises retrieving a second set of features including retrieving a second set of features and context information associated with a second smoking event on the second road link. The method comprises providing, as an input, the retrieved second set of features to a machine learning (ML) model. The ML model is trained on a first set of features associated with at least a first road link to predict a first probability score associated with usage of at least one smoking product by a first user on the first road link. The method comprises predicting a second probability score associated with the usage of the at least one smoking product by the first user on the second road link based on an output of the ML model. The method comprises comparing the second probability score with a pre-determined threshold probability score. The method comprises generating an output based on the comparison of the second probability score with the pre-determined threshold probability score. The method comprises rendering the generated output.

According to another embodiment, a system for prediction of usage of smoking products in vehicles using machine learning is provided. The system comprises at least one processor configured to retrieve a second set of features including retrieving a second set of features and context information associated with a second smoking event on the second road link. The system may further provide, as an input, the retrieved second set of features to a machine learning (ML) model. The ML model is trained on a first set of features associated with at least a first road link to predict a first probability score associated with usage of at least one smoking product by a first user on the first road link. The system may further predict a second probability score associated with the usage of the at least one smoking product by the first user on the second road link based on an output of the ML model. The system may further compare the second probability score with a pre-determined threshold probability score. The system may further generate an output based on the comparison of the second probability score with the pre-determined threshold probability score. The system may further render the generated output.

According to another embodiment, a non-transitory computer-readable storage medium carries one or more sequences of one or more instructions which, when executed by one or more processors, cause, at least in part, an apparatus to perform operations. The operations comprise retrieving a second set of features and context information associated with a second smoking event on the second road link. The operations further comprise providing, as an input, the retrieved second set of features to a machine learning (ML) model. The ML model is trained on a first set of features associated with at least a first road link to predict a first probability score associated with usage of at least one smoking product by a first user on the first road link. The operations further comprise predicting a second probability score associated with the usage of the at least one smoking product by the first user on the second road link based on an output of the ML model. The operations further comprise comparing the second probability score with a pre-determined threshold probability score. The operations further comprise generating an output based on the comparison of the second probability score with the pre-determined threshold probability score. The operations further comprise rendering the generated output.

In addition, for various example embodiments described herein, the following is applicable: a computer program product may be provided. For example, a computer program product comprising instructions which, when executed by a computer, cause the computer to perform any one or any combination of methods, operations, or processes disclosed herein.

In addition, for various example method embodiments described herein, the method may be a computer-implemented method.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side, or in any shared way between a service provider and mobile device with actions being performed on both sides.

For various example embodiments, the following is applicable: An apparatus comprising means for performing a method of the claims.

Still, other aspects, features, and advantages of the invention are readily apparent from the following detailed description, simply by illustrating a number of particular embodiments and implementations, including the best mode contemplated for conducting the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of predicting the usage of smoking products in vehicles using machine learning, according to one embodiment;

FIG. 2 is a diagram of components of the system capable of predicting the usage of smoking products in vehicles using the ML Model, according to one embodiment;

FIG. 3 is a diagram depicting steps for training the ML model for predicting the usage of smoking products in vehicles, according to one embodiment;

FIG. 4 is a diagram depicting steps for predicting the probability score associated with the usage of the at least one smoking product by a user using the ML model trained in FIG. 3, according to one embodiment;

FIG. 5 is a diagram depicting training of the ML model for prediction of probability score associated with the usage of at least one smoking product by a user on a road link, according to one embodiment;

FIG. 6A is a flowchart of a method detecting a smoking event based on sensor data collected by smoke sensors, according to one embodiment;

FIG. 6B is a flowchart of a method detecting a smoking event based on sensor data collected by image capture sensors, according to one embodiment;

FIG. 6C is a flowchart of a method detecting a smoking event based on audio pattern captured by audio capture devices, according to one embodiment;

FIG. 7A is a flowchart of a method for the training of the ML model for predicting the usage of smoking products in vehicles, according to one embodiment;

FIG. 7B is a flowchart of a method for predicting the usage of smoking products in vehicles using the ML model, according to one embodiment;

FIG. 8 is a diagram of a geographic map database, according to one embodiment;

FIG. 9 is a diagram of hardware that can be used to implement an embodiment;

FIG. 10 is a diagram of a chip set that can be used to implement an embodiment; and

FIG. 11 is a diagram of a mobile terminal (e.g., handset, vehicle, or part thereof) that can be used to implement an embodiment.

### DESCRIPTION OF SOME EMBODIMENTS

Examples of a system, method, and computer program for processing user data are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

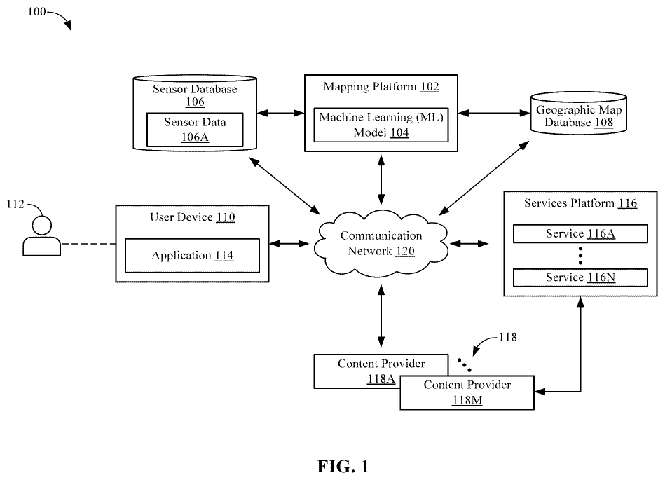

FIG. 1 is a diagram of a system 100 capable of predicting the usage of smoking products in vehicles using machine learning, according to one embodiment. The system 100 may include a mapping platform 102. The mapping platform 102 may include a machine learning model 104. The system 100 may further include sensor database 106 that include sensor data 106A and a geographic map database 108. The system 100 may further include a user device 110, a user 112, an application 114, a services platform 116, and content providers 118. The services platform 116 may include, for example, a service 116A and a service 116N. The content provider 118 may include, for example, a content provider 118A and a content provider 118M. The system 100 may further include a communication network 120. The content provider 118 or the services platform 116 may provide similar data and/or functionality to a data source.

Generally, the consumption of any smoking product while driving poses a multifaceted challenge to road safety, as it introduces distractions that can lead to impaired driving performance and an elevated risk of accidents. Some of these distractions include, but are not limited to, visual distraction, cognitive distraction, and manual distraction. Due to such distractions that result in reduced focus on the traffic environment, the likelihood of accidents increases. In addition, the health risks associated with smoking are well documented. Users of smoking products may require assistance in reducing or eliminating the triggers that cause them to smoke during driving, in order to either quit or at least manage their smoking habit.

While driving, a user in the habit of smoking may experience different situations or conditions relating to the current route, which may result in varying levels of stress or changing mood for the user. For instance, heavy traffic on a highway, a rainy day on a rural road with a full vehicle, stop-and-go situation on residential roads on after work hours, a traffic-free mountain road on weekends with a loved one, etc. are examples of situations where a user's mood or stress level may change. Such situations exhibit a combination of context information (e.g. weather, time of day, day of the week, type of journey, vehicle occupation, traffic, air quality metrics, etc.) and road features (functional class, lane count, rural road, residential road, one way road, two-way road, speed limited road, truck-free road, road surface, etc.) that may trigger the user to engage in smoking. Embodiments herein aim to determine relationships between driving situations and smoking events, so that these relationships may be utilized in predicting if any given driving situation may also trigger a user to smoke, e.g. predicting if previously observed feature combinations resulted in smoking events.

The disclosed system 100 of the present disclosure enables the prediction of usage of a smoking product by the user 112. The first user may be traveling on the first road link on a vehicle that may be associated with the user device 110. The system 100 may be configured to predict a probability score associated with the usage of the smoking product by the user 112 on a particular road link based on the set of features that may be associated with the road link. Initially, the system 100 may be configured to train the ML model 104 to predict the usage of the smoking product by a user (including the user 112) on a given road link. The system 100 may utilize smoking event data captured using one or more sensors associated with the user device 110. The smoking event data may be associated with a location corresponding to a road link. For example, a smoking event is detected while the user is at a location map-matched to a road link of the road network. The user location may be determined via e.g. a location sensor of the user device 110. The system 100 further determines a set of features corresponding to the smoking event data that includes road link properties of the road link and context information associated with the first smoking event on the road link. The system 100 further trains the ML model 104.

Once trained, the ML model 104 may be deployed in real-life scenarios to predict the probability of usage of the smoking product by the user 112 on any road link based on the set of features associated with the corresponding road link. In some embodiments, the ML model 104 may also predict the probability based on other features such as an emotional state of the user 112, weather information, and the like. Based on the predicted probability score, the system 100 may generate output indicative of alternate routes, audio and/or video messages, warning message, and the like to the user 112.

In operation, the system 100 may operate in two modes, that may be a training mode and an execution/prediction mode. During the training mode, the system 100 may retrieve first smoking event data associated with a first smoking event on a first road link. The first smoking event data may be retrieved from the at least one sensor that may be associated with the user device 110. The first smoking event data may be stored as the sensor data 106A in the sensor database 106 and may be associated with the usage of at least one smoking product by a first user (such as the user 112) on the first road link. The first user 112 may be traveling on the first road link on the vehicle that may be associated with the user device 110. In an embodiment, the smoking product may correspond to, but is not limited to, a cigarette, a cigar, a pipe tobacco, an electronic cigarette, a vape, a pod, an herbal cigarette, or a water pipe.

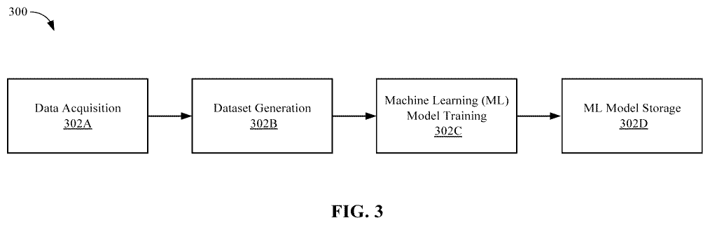

After the obtainment of the first smoking event data, the system 100 may be configured to retrieve the first set of features. The retrieved first set of features may include road link properties of the first road link and context information associated with the first smoking event on the first road link. In an embodiment, the road link properties may include, but are not limited to, a functional class, an altitude, a lane count, a speed limit, a direction of travel, road geometry (e.g. curved, straight), a rural/business/residential/mixed area designation (corresponding to where the road link is located), and the like. In an embodiment, the context information of the first set of features may include at least one of emotional state information associated with the first user, a first user profile associated with the first user, traffic information, weather information, visibility information, occupancy information, air quality information, route information, and waiting event information. Details about the first set of features are provided, for example, in FIG. 3.

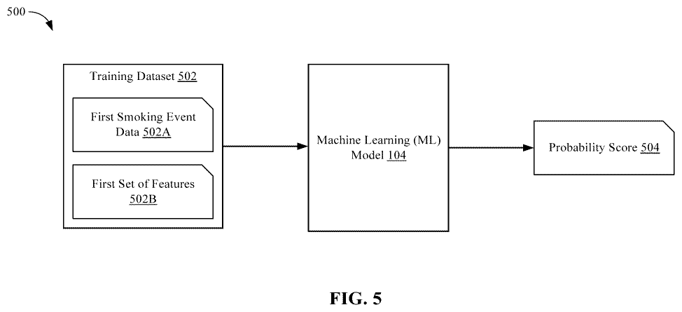

The system 100 may be further configured to train the ML model 104 using the retrieved first set of features. Specifically, the system 100 may be trained using the retrieved first set of features to determine an association between the retrieved first set of features and the first smoking event. In an embodiment, the ML model 104 may be trained to provide a first probability score associated with the usage of the at least one smoking product by the first user 112 based at least on the determined association between the first set of features and the first smoking event. In an embodiment, the system 100 may be further configured to store the trained ML model 104. Details of training the ML model 104 are further provided, for example, in FIG. 3 and FIG. 5.

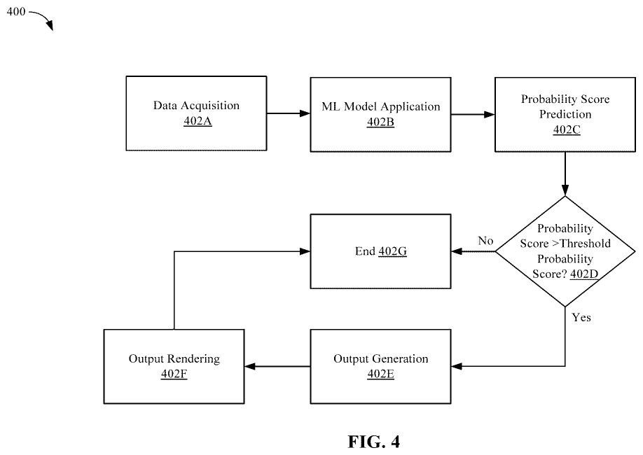

In the execution mode, the trained ML model 104 may be further deployed in real-life scenarios to predict the probability score associated with the usage of the at least one smoking product by the user 112 on the road link as described in FIG. 4. For example, the trained ML model 104 may be used to predict a second probability score associated with the usage of the at least one smoking product by the user 112 on a second road link that may be different from the first road link. Details about the execution mode are provided, for example, in FIG. 4.

It may be noted that a person with ordinary skill in the art will understand that the scope of the disclosure may not be limited to the implementation of the ML model 104 and the user device 110 as two separate entities. In certain embodiments, the ML model 104 may be incorporated in its entirety or at least partially in the user device 102 (as the data is personalized), without a departure from the scope of the disclosure.

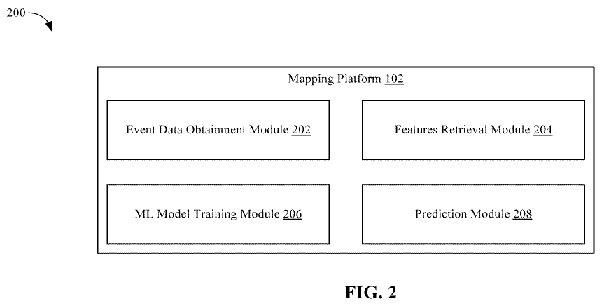

The components of the mapping platform 102 for the prediction of usage of smoking products in vehicles using the ML Model 104 are described in FIG. 2.

FIG. 2 is a diagram 200 of components of the system 100 capable of predicting usage of smoking products in vehicles using the ML Model 104, according to one embodiment. In one embodiment, as shown in FIG. 2, the mapping platform 102 of the system 100 includes one or more components capable of predicting of usage of smoking products according to the various embodiments described herein. It is contemplated that the functions of the components of the mapping platform 102 may be combined or performed by other components of equivalent functionality. As shown, in one embodiment, the mapping platform 102 includes an event data obtainment module 202, a features retrieval module 204, an ML model training module 206, and a prediction module 208. The above-presented modules and components of the mapping platform 102 can be implemented in hardware, firmware, software, or a combination thereof. Though depicted as a separate entity in FIG. 1, it is contemplated that the mapping platform 102 may be implemented as a module of any of the components of the system 100 (e.g., a component of the services platform 116, the content providers 118, the user device 110, the application 114, and/or the like). In some embodiments, the mapping platform 102 may be purposely implemented in the user device 110, for example to limit sharing of the data given the personalized nature of the smoking event data. In another embodiment, one or more of the modules 202-208 may be implemented as a cloud-based service, local service, native application, or combination thereof. The functions of the mapping platform 102 and modules 202-208 are discussed with respect to the figures below.

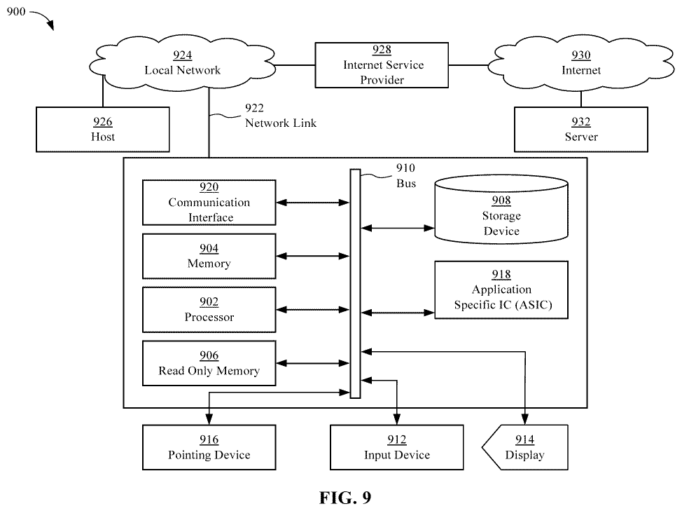

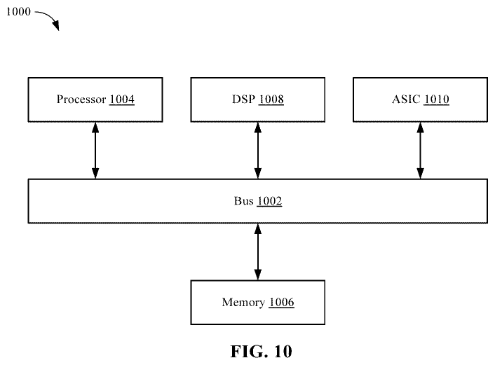

FIG. 3 is a diagram 300 depicting steps for training the ML model 104 for predicting the usage of smoking products in vehicles, according to one embodiment. In various embodiments, the mapping platform 102 and/or any of the modules 202-208 may perform one or more of the steps depicted in the diagram 300 and may be implemented in, for instance, a chip set including a processor and a memory as shown in FIG. 9 and FIG. 10. As such, the mapping platform 102 and/or any of the modules 202-208 may provide means for accomplishing various parts of the steps depicted in the diagram 300, as well as means for accomplishing embodiments of other processes described herein in conjunction with other components of the system 100. Although the diagram 300 is illustrated and described as a sequence of steps, it is contemplated that various embodiments of the method explained in the diagram 300 may be performed in any order or combination and need not include all of the illustrated steps.

At step 302A, a data acquisition operation may be performed. In the data acquisition operation, the system 100 may be configured to obtain the first smoking event data. The first smoking event data may be associated with a first smoking event by the user 112 on a first road link. Specifically, the first smoking event may be associated with the usage of at least one smoking product by the first user on the first road link. The first smoking event data may be retrieved from at least one sensor that may be associated with a user device 110 (such as a vehicle, a mobile phone, a smartwatch, or a connected vape). In an embodiment, the at least one sensor may capture the sensor data 106A and store the captured sensor data in the sensor database 106. In an embodiment, the system 100 may be configured to obtain the first smoking event data from the at least one sensor directly or from the sensor database 106.

In an embodiment, the first user 112 may be traveling on the first road link on a vehicle associated with the user device 110. The first user 112 may be traveling in or driving the vehicle and smoking at least one smoking product. In an embodiment, the user device 110 may be either integrated with the vehicle or may be located inside the vehicle (e.g., a wearable, smartphone carried by the user 112). As discussed above, the at least one smoking product may correspond to a cigarette, a cigar, a pipe tobacco, an electronic cigarette, a vape, a pod, an herbal cigarette, or a water pipe. Such usage of the smoking product during driving or traveling in the vehicle may cause distractions (such as a visual distraction, or a cognitive distraction) to the user 112 which may lead to accidents. Therefore, the system 100 may be configured to collect the event data associated with the first smoking event. Sensor(s) of the user device 110, in particular a location sensor, may obtain location data (e.g. Lat, Lon) corresponding to the smoking event. Said location can be map-matched to a corresponding road link of the road network using well-known map-matching algorithms and a map database, such as geographical map database 108.

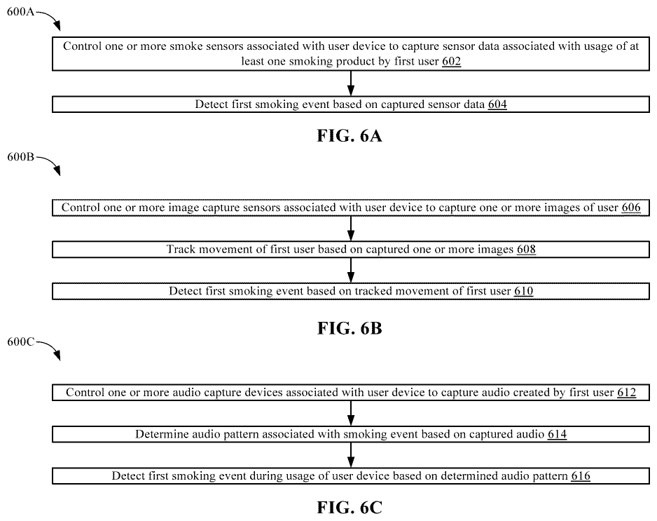

In order to detect the start of the smoking event (i.e., smoking by the user 112), the system 100 may analyze the sensor data 106A that may be captured by at least one sensor associated with the user device 110. The system 100 may be further configured to detect a behavior pattern based on sensor data collected from the at least one sensor. The behavior pattern is associated with a smoking activity and the at least one sensor comprises at least one of a smoke detector, an image capture device, an audio capture device, an infrared sensor, or a combination thereof. Details about the detection of the first smoking event are provided, for example, in FIGS. 6A, 6B, and 6C.

In an embodiment, the first smoking event data may include information such as, but not limited to, a start time of the first smoking event, an end time of the first smoking event, a duration of the first smoking event, and the like. The start time of the first smoking event may correspond to a first timestamp when the user 112 may have started using the smoking product. The end time of the first smoking event may correspond to a second timestamp when the user 112 may have stopped using the smoking product. The duration of the first smoking event may correspond to a value that may be equal to a difference between the second timestamp and the first timestamp. This value may correspond to the duration of the first smoking event.

In an embodiment, the first smoking event data may be retrieved from the sensor database 106 or directly from the at least one sensor. As shown in FIG. 1, the geographic map database 108 may be associated with the mapping platform 102. In another embodiment, the sensor database 106 may be associated with the wearable devices, or the mobile devices associated with the user 112 and may store the sensor data 106A. In some embodiments, the system 100 may be configured to analyze the sensor data 106A that may be captured by at least sensor associated with the wearable devices or mobile devices and stored in the corresponding databases associated with the wearable devices or mobile devices.

Based on the obtainment of the first smoking event data, the system 100 may be further configured to retrieve a first set of features. Similar to the first smoking event data, the first set of features may be retrieved from the geographic map database 108 and may include road link properties of the first road link and context information associated with the first smoking event on the first road link. In an embodiment, the first road link may be determined by map matching a location of the first smoking event data associated with the first smoking event. In another embodiment, the road link properties of the first road link may be retrieved from the geographic map database 108. The road link properties may include, but are not limited to, a functional class, an altitude, a lane count, a speed limit, a direction of travel, road geometry (e.g. curved, straight), a rural/business/residential/mixed area designation, and the like.

The functional class of the first road link may be used to classify roads depending on the speed, importance, and connectivity of the first road link. The altitude of the first road link may correspond to an elevation of a point on the first road link above mean sea level. The lane count may correspond to a number of lanes within the first road link. The speed limit may correspond to a maximum allowed speed on the first road link. The direction of travel may indicate a direction in which the vehicle may be travelling. The road geometry of the first road link may refers to the spatial characteristics and layout of a particular segment of first road link. The road geometry may include various aspects such as the alignment, curvature, grade, cross-section, and any other physical features that define the shape and configuration of the first road link. The area designation of the first road link road link as rural, business, residential, or mixed area typically pertains to the land use and zoning characteristics surrounding the first road link. For example, If the first road link is in a sparsely populated region with predominantly agricultural or natural land uses, it may be designated as a rural area. If the If the first road link connects to commercial centers, industrial zones, or business parks, it may be designated as a business area. In cases where the first road link primarily serves residential neighborhoods or housing developments, it may be designated as a residential area and in some instances, the first road link may traverse an area with a mix of residential, commercial, and possibly industrial uses, it may be designated as a mixed area.

As discussed above, the user 112 may be driving the user device that may be the vehicle on the first road link and may be using at least one smoking product. In another embodiment, the user 112 may be traveling on the first road link on the user device and may be using at least one smoking product. The first set of features may be captured during the first smoking event when the user 112 may be using the smoking product and driving (or riding in) the vehicle.

In an embodiment, the first set of features may further include context information associated with the first smoking event on the first road link. The context information of the first set of features may include at least one of the emotional state information associated with the user 112, a first user profile associated with the first user 112, traffic information, weather information, visibility information, occupancy information, air quality information, route information, and waiting event information.

The emotional state information associated with the user 112 may include the emotional state of the user 112 and the stress level of the user 112. The emotional state information may be retrieved because the user 112 may tend to smoke when the user 112 is not in a good state of mind or when the user 112 may be stressed or not feeling well. In an embodiment, such emotional state information may be captured by the at least one sensor associated with the user device (that may be the vehicle or the mobile device or the wearables worn by the user 112).

The first user profile associated with the user 112 may indicate whether the user 112 uses (or consumes) the smoking product, information associated with smoking preferences associated with the user 112 such as the movement of one or more hands of the user 112, a smoking pattern (or a frequency of the usage of the smoking product), most preferred smoking product, time-interval between usage of two consecutive smoking products, and the like.

The traffic information may be indicative of the traffic on the first road link at the time of the first smoking event. The weather information may be indicative of weather conditions on the first road link at the time of the first smoking event. The weather information may be indicative of the weather conditions when the user 112 uses the smoking product. For example, the user 112 may use the smoking product while raining.

The visibility information may be indicative of visibility on the first road link at the time of the first smoking event. For example, if the visibility is high, then the user 112 may use the smoking product whereas when the visibility is low, the user 112 may avoid using the smoking product.

The occupancy information may be indicative of a number of passengers with the user 112 in the user device (i.e., the vehicle) at the time of the first smoking event. In an embodiment, if the number of passengers may be greater than a pre-defined number (say 2), then the user 112 may avoid the usage of the smoking product whereas when the user 112 may be traveling along the user 112 may be less than the pre-defined number, then the user 112 may use the smoking product. For example, the user 112 may avoid the usage of the smoking products when the user 112 may be traveling with family members and prefer smoking when the user 112 is driving alone.

The air quality information may be indicative of the purity/pollution of the air associated with the user 112 location. The air quality information may relate to the external environment around the user device 112, or in the case of the user 112 device being a vehicle, the external or internal environment (e.g. vehicle cabin). For example, the user 112 may be recommended to avoid using a smoking product as current air quality information identifies a high pollution situation, which may make smoking even more harmful.

The route information may be indicative of a source and a destination of the first user 112. The route information may indicate if the user 112 uses the smoking product on the route. For example, the user 112 may use the smoking product while going home from the office. In another embodiment, if the destination of the user 112 is a smoking-restricted place (say an airport, or a metro station), then the user 112 may use the smoking product while driving. The waiting event information may be indicative of whether the user is waiting for an animated or an in-animated object to be picked up. For example, the user 112 may use the smoking product while waiting to pick-up their child from a sports arena.

In an embodiment, the first set of features may optionally include user device information. The user device information may be indicative of one or more sensors that may be installed in the user device 110. In an embodiment, the event data obtainment module 202 may be configured to retrieve the first smoking event data from the at least one sensor. Similarly, the features retrieval module 204 may be configured to retrieve the first set of features from the geographic map database 108.

In an embodiment, the first smoking event data and the first road link information may be stored in the sensor database 106 and the geographic map database 108 respectively. To store the first smoking event data and the first road link information, the system 100 may be configured to detect the first smoking event on the first road link. Based on the detection of the first smoking event, the system 100 may be configured to obtain the first set of features and further store the first set of features in the geographic map database 108 and the first smoking event data associated with the detected first smoking event in the sensor database 106.

To detect the first smoking event, the system 100 may be configured to detect a behavior pattern based on the sensor data 106A that may be collected from the at least one sensor. In an embodiment, the at least one sensor may include at least one of a smoke detector, an image capture device, an audio capture device, an infrared sensor, or a combination thereof. The behavior pattern may be associated with a smoking activity. More details about the detection of the first smoking event are provided, for example, in FIGS. 6A, 6B, and 6C.

As discussed, the first smoking event data may be captured using multiple techniques and by using the at least one sensor that may be associated with the user device 110. In an embodiment, the user device 110 may correspond to a vehicle (or an electronic control unit (ECU)) of the user 112. In another embodiment, the user device 110 may correspond to a mobile phone, a wearable device, a tablet, a personal computer, a laptop, a gaming device, or any other consumer electronic (CE) device that may be present inside the vehicle.

At 302B, a dataset generation operation may be performed. In the dataset generation operation, the system 100 may be configured to generate a training dataset. The generated training dataset may include the first smoking event data and the first set of features. Generally, the training dataset may refer to a curated collection of data used to teach the ML model 104 to perform a specific task of predicting a probability score associated with the usage of the at least one smoking product by a user on the road link. The training dataset may serve as the foundational material from which the ML model 104 may learn patterns, correlations, and features that enable the ML model 104 to make accurate predictions. Typically, the training dataset consists of input-output pairs, where the input represents the features or characteristics of the data (such as the retrieved first set of features), and the output corresponds to the desired outcome (such as the probability score). It may be noted that the quality and representativeness of the training dataset may significantly influence the ability of the ML model 104 to generalize to a new, unseen set of features.

At 302C, an ML model training operation may be executed. In the ML model training operation, the system 100 may be configured to train the ML model 104. The ML model 104 may be trained using the generated training dataset. As discussed above, the training dataset may include the first smoking event data and the retrieved first set of features. The ML model 104 may be trained to determine an association between the retrieved first set of features and the first smoking event. In an embodiment, the ML model 104 may be trained to predict a first probability score based on the determined association. The first probability score may be associated with the usage of the at least one smoking product by the user 112 on the road link. Specifically, the ML model 104 may be trained to provide the probability score associated with the usage of the at least one smoking product by the user 112 on the first road link based on the set of features associated with the first road link. In an embodiment, the ML model training module 206 may be configured to train the ML model 104 using the generated training dataset. Details about the probability score are provided, for example, in FIG. 4, and FIG. 5.

In another embodiment, the system 100 may be configured to determine a smoking product ignition pattern associated with the user 112 based on the detected first smoking event. The smoking product ignition pattern may be indicative of how the user 112 may light the smoking product. For example, the user 112 may use a lighter twice or thrice to light the at least one smoking product. Such information may be associated with the user 112 and may be stored in a user profile associated with the user 112. In an embodiment, the system 100 may train the ML model 104 based on the determined smoking product ignition pattern.

In an embodiment, the ML model 104 may be implemented as, but not limited to, a Support Vector Machines (SVM), a Decision Trees, Naive Bayes, K-Nearest Neighbors (KNN), Logistic Regression, Ensemble Methods, Linear Regression, or Neural Networks.

At 302D, an ML model storage operation may be executed. In the ML model storage operation, the system 100 may be configured to store the trained ML model 104 in the memory. In an embodiment, the ML model 104 may be stored in the mapping platform 102. The ML model 104 may be used to predict the probability score associated with the usage of the at least one smoking product by any user (including the first user) on the any road link (including the first road link) based on the set of features associated with the corresponding road link as discussed in the FIG. 4.

In an embodiment, the system 100 may be configured to update the ML model 104. To update the ML model 104, the system 100 may be configured to obtain second smoking event data associated with a second smoking event on a second road link. The second smoking event data may be obtained from the at least one sensor and may be associated with the usage of at least one smoking product by the first user 112 on the second road link. The second road link may be different from the first road link. The system 100 may be further configured to retrieve a second set of features that may include road link properties of the second road link and context information associated with the second smoking event on the second road link. Details about the road link properties are provided, for example, at 302A in FIG. 3.

The system 100 may be further configured to update the trained ML model 104 using the retrieved second set of features to determine the association between the retrieved second set of features and the second smoking event.

As discussed above, the system 100 may operate in two modes (i.e. a training mode and an execution/prediction mode). It may be noted that steps from 302A to 302D described in FIG. 3 may be performed in the training phase whereas in the execution/prediction mode, the steps defined below may be performed. In some embodiments, the trained ML model may be also updated in parallel with smoke event data and road link properties collected while on execution/prediction mode.

During the execution/prediction mode, the system 100 may be configured to retrieve a third set of features that may include road link properties of a third road link and context information associated with a third smoking event on the third road link. The system 100 may be further configured to provide the retrieved third set of features to the trained ML model 104 as an input. The system 100 may be further configured to predict a third probability score associated with the usage of the at least one smoking product by the user 112 on the third road link based on an output of the ML model. More details about the prediction of the probability score are provided, for example, in FIG. 4.

FIG. 4 is a diagram 400 depicting steps for predicting the probability score associated with the usage of the at least one smoking product by a user using the ML model 104 trained in FIG. 3, according to one embodiment. In various embodiments, the mapping platform 102 and/or any of the modules 202-208 may perform one or more of the steps depicted in the diagram 400 and may be implemented in, for instance, a chip set including a processor and a memory as shown in FIG. 9 and FIG. 10. As such, the mapping platform 102 and/or any of the modules 202-208 may provide means for accomplishing various parts of the steps depicted in the diagram 400, as well as means for accomplishing embodiments of other processes described herein in conjunction with other components of the system 100. Although the diagram 400 is illustrated and described as a sequence of steps, it is contemplated that various embodiments of the method explained in the diagram 400 may be performed in any order or combination and need not include all of the illustrated steps.

In an embodiment, the user 112 may be expected to travel on a first route. The first route may include multiple road links such as the second road link. The first route may be calculated by a routing engine, for example a routing engine associated with the mapping platform 102 or with any other services platform 116. The system 100 may be configured to determine whether the user 112 might use the at least one smoking product on the second road link. To determine whether the user 112 might use the at least one smoking product on the second road link, the below mentioned operations may be performed.

At 402A, a data acquisition operation may be executed. In the data acquisition operation, the system 100 may be configured to retrieve a second set of features. The second set of features may be retrieved from the geographic map database 108. The second set of features may be similar to the first set of features and may include road link properties of the second road link and context information associated with a second smoking event on the second road link. As discussed above, road link properties associated with the first road link may be similar to the road link properties associated with the second road link. Also, the context information associated with a second smoking event on the second road link may be similar to context information associated with the first smoking event on the first road link and may include at least one of the emotional state information associated with the user 112, a first user profile associated with the user 112, traffic information, weather information, visibility information, occupancy information, air quality information, route information, and waiting event information. Details about each of the second set of features are provided, for example, in FIG. 3.

At 402B, an ML model application operation may be executed. In the ML model application operation, the system 100 may be configured to provide the retrieved second set of features, as an input, to the ML model 104. As discussed above, the ML model 104 may be a pre-trained model that may be trained on the first set of features associated with the first road link to predict the first probability score associated with the usage of the at least one smoking product by the user 112 on the first road link. Details about the training of the ML model 104 are provided, for example, in FIG. 3.

At 402C, a probability score prediction operation may be executed. In the probability score prediction operation, the system 100 may be configured to predict a second probability score. Similar to the first probability score, the second probability score may be associated with the usage of the at least one smoking product by the user 112 on the second road link. In an embodiment, the system 100 may be configured to predict the second probability score based on an output of the ML model 104 when applied to the retrieved second set of features.

In an embodiment, the predicted second probability score may be a numerical value that may be between 0 and 1 (both inclusive). It may be noted that a higher value of the predicted second probability score may be indicative of a higher probability of the usage of the at least one smoking product by the first user while driving a vehicle or traveling using a vehicle on the second road link.

At 402D, a threshold probability comparison operation may be executed. In the threshold probability comparison operation, the system 100 may be configured to compare the second probability score with a pre-determined threshold probability score. The pre-determined threshold probability score may correspond to a minimum value of the probability score below which it might be deemed that the user might not use the smoking product while traveling on the second road link based on the second set of features associated with the second road link. As an example, the pre-determined threshold probability score may be 0.5. In case the predicted second probability score is greater than the pre-determined threshold probability score, the control may be transferred to 402E. Otherwise, the control may be transferred to the end at 402G.

In an embodiment, the steps from 402B to 402D may be repeated for a set of road links which form the first route (or may be a part of the first route). Each road link of the set of road links within the first route may be assigned with a probability score associated with the usage of the at least one smoking product by the user 112 on the corresponding road link. The probability score may be further used in the output generation operation to calculate a route that avoids road links with a probability higher than the threshold as discussed at 402E. In an embodiment, a routing engine (or the system 100) may utilize the probability values to minimize a total cost of a route (say the first route) in terms of likelihood of smoking probability. When exploring alternate road links, the routing engine may utilize the prediction process to predict the smoking likelihood on previously not analyzed road links.

At 402E, an output generation operation may be performed. In the output generation operation, the system 100 may be configured to generate the output based on comparison. Specifically, the system 100 may be configured to generate the output based on the determination that the predicted second probability score is greater than the pre-determined threshold probability score. As the predicted second probability score is greater than the pre-determined threshold probability score, it may be deemed that the user 112 may smoke while traveling on the second road link based on the second set of features associated with the second road link and the user profile.

In an embodiment, the generated output may include a second route. The second route may include at least a third road link of a set of road links. In an embodiment, a destination of the second route is the same as the destination of the first route, wherein the second route includes at least one different road link than the first route. Specifically, the second route may be an alternative route to the destination of the first route on which the user may be traveling or is expected to travel, e.g. after route calculation. In an embodiment, the second route may be travelled by the first user 112 at a later time (say after few hours). By way of example and not limitation, if the weather conditions are good, then the journey may be done later in the day (say in the evening).

In an embodiment, the third probability score associated with the usage of the at least one smoking product by the first user on the third road link may be less than at least one of the pre-determined threshold probability scores or the second probability score. The third probability score may be determined based on the application of the trained ML model 104 on the third set of features that includes road link properties of a third road link, and context information associated with a third smoking event on the third road link.

To determine the third road link, the system 100 may be configured to determine the set of road links. The source and the destination of the each road link of the determined set of road links may be same as the source and the destination of the second road link. Specifically, the system 100 may be configured to determine a set of alternative road links to the second road link. The system 100 may be further configured to retrieve the set of features associated with each of the set of road links from the geographic map database 108. Details about the set of features are provided, for example, in FIG. 3.

The system 100 may be further configured to predict a probability score associated with the usage of the at least one smoking product by the first user 112 on each of the set of road links. The probability score may be predicted based on the application of the ML model 104 on the corresponding set of features associated with the road link. Based on the predicted probability score, the system 100 may be configured to assign a score to each of the set of road links based on the probability score associated with the corresponding road link and the pre-determined threshold probability score. In an embodiment, the assigned score may be a penalty score that may be associated with the usage of the at least one smoking product on the corresponding road link. In an embodiment, the penalty score may be higher for the road links with a higher probability score. The system 100 may be further configured to determine the second route that may include at least one of the third road link of the set of road links based on the assigned score.

In an alternate embodiment, the generated output may include at least one of an audio message or a visual message. The audio message or a visual message may be associated with the prediction of usage of the at least one smoking product. In an embodiment, the audio message or the visual message may indicate one or more health issues and/or the disruptions that may be caused by using the at least one smoking product on any road link. Such output may be generated to convince the user 112 to quit the usage of at least one smoking product, before consumption of the product even occurs.

In an alternative embodiment, the audio message or the visual message may convince the first user to use at least one smoking product. For example, the audio message or the visual message may convince the first user to use the smoking product when the user 112 may be waiting for the animated or the in-animated object. Such information about waiting for the animated or the in-animated object may be included in the waiting information that may be included in the second set of features. In another embodiment, it may be determined that the user 112 may use the at least one smoking product after a time period (say after 10 minutes). The system 100 may determine the traffic conditions on the second road link after 10 minutes. In case, the traffic conditions indicate that the traffic will be more after 10 minutes as compared to the current traffic, then the system 100 may generate the output that may convince the user 112 to use the smoking product now.

At 402F, an output rendering operation may be executed. In the output rendering operation, the system 100 may be configured to provide the determined second route. In an embodiment, the output may be provided via the user device 110 which may include a vehicle, an autonomous vehicle, a mobile device, or a smartwatch that may be associated with the user 112.

In an embodiment, the system 100 may be configured to render the generated output. In case the generated output corresponds to the third road link or the visual message, the generated output may be provided (or rendered) via a display screen associated with the user device that may correspond to the vehicle, the mobile phone, the smartwatch, and the like. In case the generated output corresponds to the audio message, the generated output may be provided (or rendered) through the one or more audio rendering devices associated with the user device 110. In another embodiment, the system 100 may be configured to generate a warning message that may be associated with the usage of the at least one smoking product by one or more users on the second road link and render the generated warning message.

In an embodiment, the system 100 may be further configured to monitor the first user 112 traveling on the third road link on a vehicle associated with a user device for the usage of the at least one smoking product based on sensor data captured by at least one sensor. The at least one sensor may be associated with the user device 110. Based on the monitoring, the system 100 may be configured to update the ML model 104. In another embodiment, the system 100 may be configured to display the generated output on the electronic billboards that may be installed along the second road link.

In an embodiment, the mapping platform 102 may be further configured to train the ML model 104, further explained in FIG. 5.

FIG. 5 is a diagram 500 depicting training of the ML model 104 for the prediction of probability score associated with the usage of at least one smoking product by a user on a road link, according to one embodiment. The diagram 500 may include the ML model 104, a training dataset 502, and a probability score 504. The training dataset 502 may include a first smoking event data 502A associated with a first smoking event and a first set of features 502B including first road link information.

In some embodiments, the first smoking event data 502A may be associated with the first smoking event. The first smoking event may be associated with the usage of at least one smoking product by the user 112 on the first road link. The first smoking event data 502A may be retrieved from the sensor database 106 based on a consent from a set of users that may be authorized to provide the consent to use the first smoking event information. For example, the set of users may be users of the mapping platform 102 whose data may have been collected with the consent of the set of users.

The first set of features 502B may include first road link information associated with the first road link. Specifically, the first set of features 502B may include road link properties of the first road link and context information associated with the at least one smoking event on the first road link. The context information associated with the at least one smoking event on the first road link may include at least one of emotional state information associated with the first user 112, a first user profile associated with the first user 112, traffic information, weather information, visibility information, occupancy information, air quality information, route information, and waiting event information. Details about the first set of features 502B are provided, for example, in FIG. 3.

In some embodiments, the mapping platform 102 may be configured to train the ML model 104 to predict the probability score 504 associated with the usage of the at least one smoking product by the user 112 on the first road link. The ML model 104 may be, for example, a prediction model that may be trained to predict the probability score associated with the usage of the at least one smoking product by the user 112 on the road link whose set of features may be provided as the input. The mapping platform 102 may provide, as a training input, the training dataset 502 to the ML model 104. The mapping platform 102 may further receive, as a training output, the probability score 504. The ML model 104 may be trained until an error rate associated with the training output is less than a threshold. Further details about the training of the ML model 104 are provided, for example, in FIG. 1 and FIG. 3.

FIG. 6A is a flowchart of a method 600A detecting a smoking event based on sensor data collected by smoke detector, according to one embodiment. In various embodiments, the mapping platform 102 and/or any of the modules 202-208 may perform one or more portions of the method 600A and may be implemented in, for instance, a chip set including a processor and a memory as shown in FIG. 9 and FIG. 10. As such, the mapping platform 102 and/or any of the modules 202-208 may provide means for accomplishing various parts of the method 600A, as well as means for accomplishing embodiments of other processes described herein in conjunction with other components of the system 100. Although the method 600A is illustrated and described as a sequence of steps, it is contemplated that various embodiments of the method 600A may be performed in any order or combination and need not include all of the illustrated steps.

In an embodiment, the user device 110 that may correspond to the vehicle or an electronic device (such as the mobile device associated with the user 112) may include at least one smoke detector. The smoke detector may include suitable logic, circuitry, interfaces, and/or code that may be configured to detect the presence of smoke in the surrounding air, indicative of a potential smoking event or a potential fire. Examples of different types of smoke detectors may include ionization smoke detectors and photoelectric smoke detectors. The ionization smoke detectors may use a small amount of radioactive material to ionize the air, creating a current that may be disrupted by smoke particles, triggering the detection of the smoking event whereas the photoelectric smoke detectors may utilize a light source and a sensor. When smoke enters the chamber, it scatters the light, leading to a reduction in the light reaching the sensor. This may be indicative of the detection of the smoking event or the fire.

At 602, the at least one smoke detector may be controlled. In an embodiment, the system 100 may be configured to control the at least one smoke detector to capture the sensor data 106A associated with the usage of at least one smoking product by the user 112. As discussed above, the at least one smoke detector may be associated with the user device 110. In an embodiment, the at least one smoke detector may be integrated within the user device 110. In another embodiment, the at least one smoke detector may be an external sensor that may be coupled with the user device 110, for example via a universal serial bus (USB) port. The at least one smoke detector may be further configured to transmit the captured sensor data 106A to the system 100.

At 604, the first smoking event may be detected. In an embodiment, the system 100 may be configured to detect the first smoking event based on the captured sensor data 106A. In an embodiment, the system 100 may be configured to analyze the sensor data 106A captured by the at least one smoke detector. Based on the analysis, the system 100 may be configured to detect the first smoking event. As soon as the first smoking event is detected, the system 100 may be configured to capture the first set of features that may be associated with the first road link and store the first set of features in the geographic map database 108. In an embodiment, the system 100 may be further configured to analyze the sensor data 106A that may be captured by the at least one smoke detector continuously until the sensor data is indicative of a stoppage of the first smoking event. Until the stoppage of the first smoking event, the system 100 may be configured to continuously capture the first set of features. The system 100 may be further configured to store the captured first set of features in the geographic map database 108. The system 100 may be further configured to determine the first smoking event data associated with the detected first smoking event and store the captured first smoking event data in the sensor database 106. Control may pass to the end.

FIG. 6B is a flowchart of a method 600B detecting a smoking event based on sensor data collected by an image capture device, according to one embodiment. In various embodiments, the mapping platform 102 and/or any of the modules 202-208 may perform one or more portions of the method 600B and may be implemented in, for instance, a chip set including a processor and a memory as shown in FIG. 9 and FIG. 10. As such, the mapping platform 102 and/or any of the modules 202-208 may provide means for accomplishing various parts of the method 600B, as well as means for accomplishing embodiments of other processes described herein in conjunction with other components of the system 100. Although the method 600B is illustrated and described as a sequence of steps, it is contemplated that various embodiments of the method 600B may be performed in any order or combination and need not include all of the illustrated steps.

In an embodiment, the user device 110 that may correspond to the vehicle or an electronic device (such as the mobile device associated with the user 112) may include an image capture device. The image capture device may include suitable logic, circuitry, and interfaces that may be configured to capture one or more images of the user 112 who may be driving the vehicle or sitting inside the vehicle. In an embodiment, the image capture device may be disposed inside the vehicle in such a way that the image capture device may capture one or more images of the user 112. In some embodiments, the image capture device may be disposed on an inner surface of the vehicle such that the disposed image capture device may capture the one or more images of the user 112 present inside the vehicle. In such case, the image capture device disposed of in the vehicle may transmit the captured one or more images to the system 100. In another embodiment, the one or more image capture sensors may be associated with other user devices such as the mobile phone, the tablet, or the wearable device associated with the user 112. Examples of each of the image capture device may include, but are not limited to, an image sensor, a charge coupled device (CCD), a wide-angle camera, an action camera, a closed-circuit television (CCTV) camera, a camcorder, a digital camera, camera phones, a time-of-flight camera (ToF camera), a night-vision camera, a 360-degree camera, and/or other image capturing sensors.

At 606, the image capture device may be controlled. In an embodiment, the system 100 may be configured to control the image capture device to capture one or more images of the user 112 inside the vehicle. As discussed above, the image capture device may be associated with the user device 110 and may be further configured to transmit the captured one or more images of the user 112 to the system 100.

At 608, a movement of the user may be tracked. In an embodiment, the system 100 may be configured to track the movement of the user 112 based on the captured one or more images of the user 112. Specifically, the system 100 may be configured to track the movement of the one or more body parts such as, but not limited to, the mouth of the user 112, hands of the user 112, and the like. It may be deemed that the user 112 may be moving one or more body parts while smoking the at least one smoking product.

At 610, the first smoking event may be detected. In an embodiment, the system 100 may be configured to detect the first smoking event based on the tracked movement of the user 112. Such movement of the user 112 may be indicative of the behavior pattern of the user 112. By way of example, during smoking, the user 112 may continuously move his hand from a first position (say from lips) to a second position (say arm rest of the vehicle). As another example, the user 112 may continuously move their lips during the usage of the at least one smoking product. Such movements may be indicative of the usage of at least one smoking product by the user 112. As soon as the first smoking event is detected, the system 100 may be configured to capture the first set of features that may be associated with the first road link. In an embodiment, the system 100 may be further configured to continuously track the movement of the one or more body parts of the user 112 until the user stops using the at least one smoking product thereby stopping the movement of the one or more body parts of the user 112. The system 100 may be further configured to store the captured first set of features in the geographic map database 108. The system 100 may be further configured to determine the first smoking event data associated with the detected first smoking event and store the captured first smoking event data in the sensor database 106. Control may pass to the end.

FIG. 6C is a flowchart of a method 600C detecting a smoking event based on an audio pattern captured by an audio capture device, according to one embodiment. In various embodiments, the mapping platform 102 and/or any of the modules 202-208 may perform one or more portions of the method 600C and may be implemented in, for instance, a chip set including a processor and a memory as shown in FIG. 9 and FIG. 10. As such, the mapping platform 102 and/or any of the modules 202-208 may provide means for accomplishing various parts of the method 600C, as well as means for accomplishing embodiments of other processes described herein in conjunction with other components of the system 100. Although the method 600C is illustrated and described as a sequence of steps, it is contemplated that various embodiments of the method 600C may be performed in any order or combination and need not include all of the illustrated steps.

In an embodiment, the user device that may correspond to the vehicle or an electronic device (such as the mobile device associated with the user 112) may include at least one audio capture device. The at least one audio capture device may include suitable logic, circuitry, and/or interfaces that may be configured to capture an audio created by the user 112. The at least one audio capture device may be further configured to convert the captured audio into an electrical signal. In an embodiment, each of the one or more audio capture devices may be a mono-microphone installed in the user device. Examples of the audio capture device may include, but are not limited to, a recorder, an electret microphone, a dynamic microphone, a carbon microphone, a piezoelectric microphone, a fiber microphone, a (micro-electro-mechanical systems) MEMS microphone, or other microphones known in the art.

At 612, the at least one audio capture device may be controlled. In an embodiment, the system 100 may be configured to control the at least one audio capture device to capture audio created by the user 112 during the usage of at least one smoking product. The at least one audio capture device may be integrated within the user device 110 (that may be the vehicle, or a mobile phone associated with the user 112). After capturing the audio created by the user 112, the at least one audio capture device may be configured to transmit the captured audio to the system 100.

At 614, an audio pattern may be determined. In an embodiment, the system 100 may be configured to determine an audio pattern from the received audio that may be created by the user 112 and captured by the at least one audio capture device. In an embodiment, the user 112 while smoking at least one smoking product may create a unique audio pattern which may be indicative of the usage of the smoking product. Such audio pattern may be indicative of a behavior pattern associated with the smoking activity. For example, the audio pattern may be associated with air intake (inhaling) and releasing smoke (exhaling). While in-taking air and releasing smoke, the user 112 may create an audio pattern that may be indicative of the usage of at least one smoking product by the user 112.

At 616, the first smoking event may be detected. In an embodiment, the system 100 may be configured to detect the first smoking event based on the determined audio pattern. As soon as the first smoking event is detected, the system 100 may be configured to capture the first set of features that may be associated with the first road link. In an embodiment, the system 100 may be further configured to continuously determine the audio pattern until the user 112 stops using the at least one smoking product. The system 100 may be further configured to store the captured first set of features in the geographic map database 108. The system 100 may be further configured to determine the first smoking event data associated with the detected first smoking event and store the captured first smoking event data in the sensor database 106. Control may pass to the end.

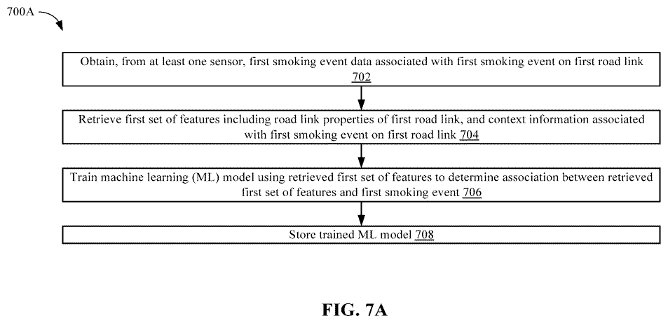

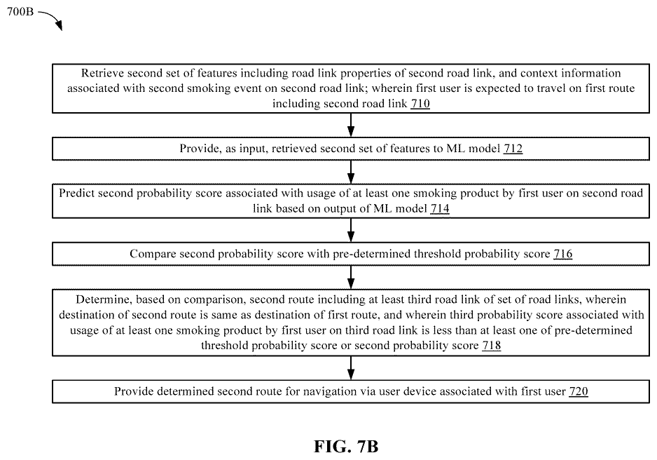

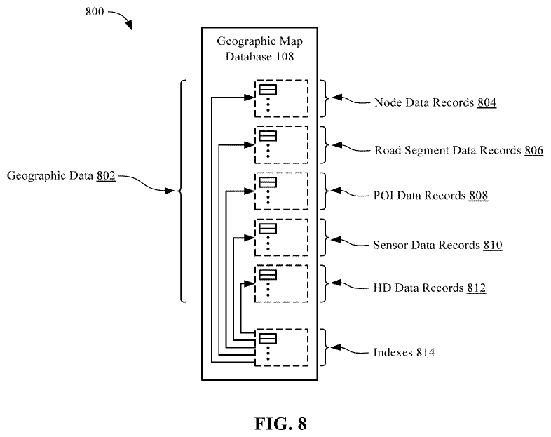

FIG. 7A is a flowchart of a method 700A for the training of the ML model for predicting the usage of smoking products in vehicles, according to one embodiment. In various embodiments, the mapping platform 102 and/or any of the modules 202-208 may perform one or more portions of the method 700 and may be implemented in, for instance, a chip set including a processor and a memory as shown in FIG. 9 and FIG. 10. As such, the mapping platform 102 and/or any of the modules 202-208 may provide means for accomplishing various parts of the method 700A, as well as means for accomplishing embodiments of other processes described herein in conjunction with other components of the system 100. Although the method 700A is illustrated and described as a sequence of steps, it is contemplated that various embodiments of the method 700A may be performed in any order or combination and need not include all of the illustrated steps.

At step 702, the first smoking event data may be obtained. In some embodiments, the event data obtainment module 202 may be configured to obtain the first smoking event data from the geographic map database 108. In an embodiment, the first smoking event data may be associated with the first smoking event on a first road link. The first smoking event may be associated with the usage of at least one smoking product by the first user 112 on the first road link. Details about the obtainment of the first smoking event data are further provided, for example, at step 302A in FIG. 3 and FIG. 4.

At step 704, the first set of features may be retrieved. In some embodiments, the features retrieval module 204 may be configured to retrieve the first set of features based on the retrieved first smoking event data. The first set of features may include road link properties of the first road link and context information associated with the first smoking event on the first road link. Details of the retrieval of the first set of features data are further provided, for example, at step 302A in FIG. 3.

At step 706, the ML model 104 may be trained. In some embodiments, the ML model training module 206 may be configured to train the ML model using the retrieved first set of features to determine an association between the retrieved first set of features and the first smoking event. Details of training the ML model are further provided, for example, at step 302C in FIG. 3.

At step 708, the trained ML model may be stored as described, at step 308D in FIG. 3. Control may pass to end.

FIG. 7B is a flowchart of a method 700B for predicting the usage of smoking products in vehicles using the ML model, according to one embodiment. In various embodiments, the mapping platform 102 and/or any of the modules 202-208 may perform one or more portions of the method 700 and may be implemented in, for instance, a chip set including a processor and a memory as shown in FIG. 9 and FIG. 10. As such, the mapping platform 102 and/or any of the modules 202-208 may provide means for accomplishing various parts of the method 700B, as well as means for accomplishing embodiments of other processes described herein in conjunction with other components of the system 100. Although the method 700B is illustrated and described as a sequence of steps, it is contemplated that various embodiments of the method 700B may be performed in any order or combination and need not include all of the illustrated steps.

At step 710, the second set of features may be retrieved. In some embodiments, the features retrieval module 204 may be configured to retrieve the second set of features. The second set of features may include road link properties of a second road link and context information associated with a second smoking event on the second road link. In an embodiment, the first user may be expected to travel on a first route that may include the second road link. Details of the determination of the second set of features data are further provided, for example, at step 402A in FIG. 4.

At step 712, the retrieved second set of features may be provided as input to the ML model 104. In an embodiment, the prediction module 208 may be configured to provide the retrieved second set of features to the ML model 104.

At step 714, the second probability score may be predicted. In an embodiment, the prediction module 208 may be configured to predict the second probability score associated with the usage of the at least one smoking product by the first user on the second road link based on an output of the ML model 104. In an embodiment, the system 100 may be configured to predict a second probability score associated with the usage of the at least one smoking product by the first user on the second road link based on an output of the ML model 104. Details about the prediction of the second probability score are further provided, for example, at step 402C in FIG. 4.

At 716, the second probability score may be compared with a pre-determined threshold probability score. In an embodiment, the system 100 may be configured to compare the second probability score with a pre-determined threshold probability score. Details about the pre-determined threshold probability score are further provided, for example, at step 402D in FIG. 4

At step 718, the second route including at least a third road link of a set of road links may be determined based on the comparison. The destination of the second route is the same as the destination of the first route. Also, the third probability score associated with the usage of the at least one smoking product by the first user on the third road link is less than at least one of the pre-determined threshold probability score or the second probability score. Details about the determined second route are further provided, for example, at step 402E in FIG. 4.

At 720, the determined second route may be provided as an output for navigation. In an embodiment, the system 100 may be configured to provide the determined second route for navigation via the user device 110 associated with the first user 112. Details about the providing of the generated output are further provided, for example, at step 402F in FIG. 4.

Returning to FIG. 1, as shown, the system 100 includes the mapping platform 102 for processing the sensor data 108A captured by different types of sensors such as the smoke sensors, the one or more image capture sensors, and the like. The services platform 116 may include one or more services, such as the service 116A and the service 116N. The content providers 118 may further include one or more content providers, such as the content provider 118A and the content provider 118M.

In one embodiment, the mapping platform 102 has connectivity over the communication network 120 to the services platform 116 that provides the one or more services, such as the service 116A and the service 116N that can use the sensor data 108A for downstream functions. By way of example, the service 116A and the service 116N may be third-party services and include but are not limited to mapping services, navigation services, travel planning services, notification services, social networking services, content (e.g., audio, video, images, etc.) provisioning services, application services, storage services, contextual information determination services, location-based services, information-based services (e.g., weather, news, etc.), etc. In one embodiment, the service 116A and the service 116N use the output of the mapping platform 102 (e.g., the sensor data 106A stored in the sensor database 106, maps stored in the geographic map database 108, etc.) to provide services such as navigation, mapping, other location-based services, etc. to the user device 110, the application 114, and/or other client devices. In one embodiment, the service platform 116 may act as a content provider, analogously to content provider 118A, providing the sensor data 108A to the mapping platform 102, either directly or via the sensor database 106. In some embodiments, the sensor database 106 and the geographic map database 108 may also be one of the content providers 118 or the services platform 116.

In one embodiment, the mapping platform 102 may be a platform with multiple interconnected components. The mapping platform 102 may include multiple servers, intelligent networking devices, computing devices, components, and corresponding software for processing of the sensor data 108A according to the various embodiments described herein. In addition, it is noted that the mapping platform 102 may be a separate entity of the system 100, a part of the service 116A, and the service 116N, a part of the services platform 116, or included within components of the user device 110.

In one embodiment, the content providers 118 may provide content or data (e.g., the sensor data 108a, probe data, related geographic data, etc.) to the geographic map database 108, the mapping platform 102, the services platform 116, the service 116a and the service 116n, the user device 110, and/or the application 114 executing on the user device 110. the content provided may be any type of content, such as sensor data 108a, other contextual data (such as weather data, air quality data, calendar data, event data, transport schedules), sensor data, imagery, probe data, machine learning models, permutations matrices, map embeddings, map content, textual content, video content, image content, etc., for example, obtained via the user device 110. in one embodiment, the content providers 118 may provide content that may aid in processing of the sensor data 106A, the other contextual data, etc. according to the various embodiments described herein. in one embodiment, the content providers 118 may also store content associated with the geographic map database 108, the mapping platform 102, the services platform 116, the service 116A and the service 116N, and/or any other component of the system 100. In another embodiment, the content providers 118 may manage access to a central repository of data, and offer a consistent, standard interface to data, such as a repository of the geographic map database 108.

In one embodiment, the user device 110 may execute software applications to use the sensor data 106A or other data derived therefrom according to the embodiments described herein. By way of example, the applications 114 may also be any type of application that is executable on the user device 110, such as autonomous driving applications, routing applications, mapping applications, location-based service applications, navigation applications, device control applications, content provisioning services, camera/imaging application, media player applications, social networking applications, calendar applications, and the like. in one embodiment, the application 114 may function as a client for the mapping platform 102 and perform one or more functions associated with the processing of the sensor data 106A alone or in combination with the mapping platform 102.

By way of example, the user device 110 is or can include any type of vehicle. embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the user device 110 can support any type of interface to the user (such as “wearable” circuitry, etc.). In one embodiment, the user device 110 may be associated with or be a component of the vehicle or any other device.

In one embodiment, the user device 110 is configured with various sensors for collection of the sensor data 108A that may include location data, such as related geographic data, etc. In one embodiment, the location data included in the sensor data 108A represent data associated with a geographic location or coordinates at which sensor data was collected, and the polyline or polygonal representations of detected objects of interest derived therefrom to generate the digital map data of the geographic map database 108. In an example, the location data may be utilized to generate the mobility pattern data. By way of example, the sensors may include a global navigation satellite sensor (GNSS) for gathering location data (e.g., GPS, GALILEO, BEIDOU, GLONASS), Inertial Measurement Units (IMUs), a network detection sensor for detecting wireless signals or receivers for different short-range communications (e.g., Bluetooth, Wi-Fi, Li-Fi, near field communication (NFC), etc.), temporal information sensors, a camera/imaging sensor for gathering image data (e.g., the camera sensors may automatically capture road sign information, images of road obstructions, etc. for analysis), an audio recorder for gathering audio data, velocity sensors mounted on steering wheels of the vehicles, magnetometer, switch sensors for determining whether one or more vehicle switches are engaged, and the like. Furthermore, data in the geographic map database 108 and other context data source such as weather data, air quality data, calendar, transport schedules, event data, and the like may also be utilized to generate the mobility pattern data. Thus, the mobility pattern data may be assembled by using the user device 110, the geographic map database 108, and the other context data source.

Other examples of sensors of the user device 110 may include light sensors, orientation sensors augmented with height sensors and acceleration sensors, tilt sensors to detect the degree of incline or decline (e.g., slope) along a path of travel, moisture sensors, pressure sensors, etc. in a further example embodiment, sensors about the perimeter of the user device 110 may detect the relative distance of the device or vehicle from a lane or roadway, the presence of other vehicles, pedestrians, traffic lights, potholes and any other objects, or a combination thereof. in one scenario, the sensors may detect weather data, air quality data, traffic information, or a combination thereof. in one embodiment, the user device 110 may include GPS or other satellite-based receivers to obtain geographic coordinates from positioning satellites for determining current location and time. Further, the location can be determined by visual odometry, triangulation systems such as A-GPS, Cell of Origin, or other location extrapolation technologies.

In one embodiment, the communication network 120 of the system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short-range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, 5G New Radio networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the mapping platform 102, the services platform 116, the service 116A and the service 116N, the user device 110, and/or the content providers 118 communicate with each other and other components of the system 100 using well-known, new, or still developing protocols. In this context, a protocol includes a set of rules defining how the network nodes within the communication network 120 interact with each other based on information sent over the communication links. The protocols are effective at different layers of operation within each node, from generating and receiving physical signals of various types to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically affected by exchanging discrete packets of data. Each packet typically comprises (1) header information associated with a particular protocol and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a datalink (layer 2) header, an internetwork (layer 3) header and a transport (layer 4) header, and various application (layer 5, layer 6 and layer 7) headers as defined by the OSI Reference Model.

FIG. 8 is a diagram of the geographic map database 108, according to one embodiment. In one embodiment, the geographic map database 108 includes geographic data 802 used for (or configured to be compiled to be used for) mapping and/or navigation-related services, such as for providing map embedding analytics according to the embodiments described herein. For example, the map data records stored herein can be used to determine the semantic relationships among the map features, attributes, categories, etc. represented in the geographic data 802. In one embodiment, the geographic map database 108 includes high definition (HD) mapping data that provide centimeter-level or better accuracy of map features. For example, the geographic map database 108 can be based on Light Detection and Ranging (LiDAR) or equivalent technology to collect billions of 3D points and model road surfaces and other map features down to the number of lanes and their widths. In one embodiment, the HD mapping data (e.g., HD data records 812) and/or other mapping data of the geographic map database 108 capture and store details such as but not limited to road attributes and/or other features related to generating speed profile data. These details include but are not limited to road width, number of lanes, turn maneuver representations/guides, traffic lights, light timing/stats information, slope and curvature of the road, lane markings, and roadside objects such as signposts, including what the signage denotes. By way of example, the HD mapping data enables highly automated vehicles to precisely localize themselves on the road.

In one embodiment, geographic features (e.g., two-dimensional, or three-dimensional features) are represented using polylines and/or polygons (e.g., two-dimensional features) or polygon extrusions (e.g., three-dimensional features). In one embodiment, these polylines/polygons can also represent ground truth or reference features or objects (e.g., signs, road markings, lane lines, landmarks, etc.) used for visual odometry. For example, the polylines or polygons can correspond to the boundaries or edges of the respective geographic features. In the case of a building, a two-dimensional polygon can be used to represent the footprint of the building, and a three-dimensional polygon extrusion can be used to represent the three-dimensional surfaces of the building. Accordingly, the terms polygons and polygon extrusions as used herein can be used interchangeably.

In one embodiment, the following terminology applies to the representation of geographic features in the geographic map database 108.
“Node”—A point that terminates a link.
“Line segment”—A straight line connecting two points.
“Link” (or “edge”)—A contiguous, non-branching string of one or more line segments terminating in a node at each end.
“Shape point”—A point along a link between two nodes (e.g., used to alter a shape of the link without defining new nodes).
“Oriented link”—A link that has a starting node (referred to as the “reference node”) and an ending node (referred to as the “non-reference node”).
“Simple polygon”—An interior area of an outer boundary formed by a string of oriented links that begins and ends in one node. In one embodiment, a simple polygon does not cross itself.
“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic map database 108 follows certain conventions. For example, links do not cross themselves and do not cross each other except at a node. Also, there are no duplicated shape points, nodes, or links. Two links that connect to each other have a common node. In the geographic map database 108, overlapping geographic features are represented by overlapping polygons. When polygons overlap, the boundary of one polygon crosses the boundary of the other polygon. In the geographic map database 108, the location at which the boundary of one polygon intersects the boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic map database 108 includes node data records 804, road segment or link data records 806, POI data records 808, sensor data records 810, HD mapping data records 812, and indexes 814, for example. In some examples, the sensor data 108A may be stored as the node data records 804, the road segment or the link data records 806, the POI data records 808, the sensor data records 810, the HD mapping data records 812, and the indexes 814. More, fewer, or different data records can be provided. In some embodiments, the sensor data records 810 may be stored in the geographic map database 108 or the sensor database 106. In one embodiment, additional data records (not shown) can include cartographic (“carto”) data records, routing data, and maneuver data. In one embodiment, the indexes 814 may improve the speed of data retrieval operations in the geographic map database 108. In one embodiment, the indexes 814 may be used to quickly locate data without having to search every row in the geographic map database 108 every time it is accessed. For example, in one embodiment, the indexes 814 can be a spatial index of the polygon points associated with stored feature polygons. In one or more embodiments, data of a data record may be attributes of another data record.

In exemplary embodiments, the road segment data records 806 are links or segments representing roads, streets, paths, or bicycle lanes, as can be used in the calculated route or recorded route information for the determination of speed profile data. The node data records 804 are endpoints (for example, representing intersections or an end of a road) corresponding to the respective links or segments of the road segment data records 806. The road segment data records 806 and the node data records 804 represent a road network, such as used by vehicles, cars, and/or other entities. Alternatively, the geographic map database 108 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation-related attributes, as well as POIs, such as gasoline stations, hotels, restaurants, museums, stadiums, offices, automobile dealerships, auto repair shops, buildings, stores, parks, etc. The geographic map database 108 can include data about the POIs and their respective locations in the POI data records 808. The geographic map database 108 can also include data about road attributes (e.g., traffic lights, stop signs, yield signs, roundabouts, lane count, road width, lane width, etc.), places, such as cities, towns, or other communities, and other geographic features, such as bodies of water, mountain ranges, etc. Such place or map feature data can be part of the POI data records 808 or can be associated with POIs or POI data records 808 (such as a data point used for displaying or representing a position of a city).

In one embodiment, the geographic map database 108 can also include the sensor data records 810 for storing the sensor data 108A, and/or any other related data that is used or generated according to the embodiments described herein. By way of example, the sensor data records 810 can be associated with one or more of the node records 804, the road segment records 806, and/or the POI data records 808 to associate the speed profile data records with specific places, POIs, geographic areas, and/or other map features. In this way, the linearized data records can also be associated with the characteristics or metadata of the corresponding records 804, 806, and/or 808.

In one embodiment, as discussed above, the HD mapping data records 812 model road surfaces and other map features to centimeter-level or better accuracy. The HD mapping data records 812 also include ground truth object models that provide the precise object geometry with polylines or polygonal boundaries, as well as rich attributes of the models. These rich attributes include, but are not limited to, object type, object location, lane traversal information, lane types, lane marking types, lane level speed limit information, and/or the like. In one embodiment, the HD mapping data records 812 are divided into spatial partitions of varying sizes to provide HD mapping data to end-user devices with near real-time speed without overloading the available resources of the devices (e.g., computational, memory, bandwidth, etc. resources).

In one embodiment, the HD mapping data records 812 are created from high-resolution 3D mesh or point-cloud data generated, for instance, from LiDAR-equipped vehicles. The 3D mesh or point-cloud data are processed to create 3D representations of a street or geographic environment at centimeter-level accuracy for storage in the HD mapping data records 812.

In one embodiment, the HD mapping data records 812 also include real-time sensor data collected from probe vehicles in the field. The real-time sensor data, for instance, integrates real-time traffic information, weather, air quality data, and road conditions (e.g., potholes, road friction, road wear, etc.) with highly detailed 3D representations of street and geographic features to provide precise real-time data (e.g., including probe trajectories) also at centimeter-level accuracy. Other sensor data can include vehicle telemetry or operational data such as windshield wiper activation state, braking state, steering angle, accelerator position, and/or the like.

In one embodiment, the geographic map database 108 can be maintained by the content provider 118 in association with the mapping platform 102 (e.g., a map developer or service provider). The map developer can collect geographic data to generate and enhance the geographic map database 108. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used.

The geographic map database 108 can be a master geographic map database stored in a format that facilitates updating, maintenance, and development. For example, the master geographic map database or data in the master geographic map database can be in an Oracle spatial format or other format (e.g., capable of accommodating multiple/different map layers), such as for development or production purposes. The Oracle spatial format or development/production database can be compiled into a delivery format, such as a geographic data files (GDF) format. The data in the production and/or delivery formats can be compiled or further compiled to form geographic map database products or databases, which can be used in end-user navigation devices or systems.

For example, geographic data is compiled (such as into a platform specification format (PSF)) to organize and/or configure the data for performing navigation-related functions and/or services, such as route calculation, route guidance, map display, speed calculation, distance and travel time functions, and other functions, by a navigation device, such as by vehicle and/or the USER DEVICE 110. The navigation-related functions can correspond to vehicle navigation, pedestrian navigation, or other types of navigation. The compilation to produce the end-user databases can be performed by a party or entity separate from the map developer. For example, a customer of the map developer, such as a navigation device developer or other end user device developer, can perform compilation on a received geographic map database in a delivery format to produce one or more compiled navigation databases.

The processes described herein for processing the sensor data 108A may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

FIG. 9 is a diagram of hardware that can be used to implement an embodiment. Computer system 900 is programmed (e.g., via computer program code or instructions) for processing the sensor data 108A as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic, and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

The bus 910 includes one or more parallel conductors of information so that information is transferred quickly among devices coupled to the bus 910. One or more processors 902 for processing information are coupled with the bus 910.

A processor 902 performs a set of operations on information as specified by computer program code related to the processing of the sensor data 108A. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations includes bringing information in from the bus 910 and placing information on the bus 910. The set of operations also typically includes comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitutes processor instructions, also called computer system instructions or, simply, computer instructions. Processors may be implemented as mechanical, electrical, magnetic, optical, chemical, or quantum components, among others, alone or in combination.

The computer system 900 also includes a memory 904 coupled to bus 910. The memory 904, such as a random access memory (RAM) or other dynamic storage device, stores information including processor instructions for processing the sensor data 108A. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during the execution of processor instructions. The computer system 900 also includes a read-only memory (ROM) 906 or other static storage device coupled to the bus 910 for storing static information, including instructions, which is not changed by the computer system 900. Some memory is composed of volatile storage that loses the information stored thereon when power is lost. Also coupled to the bus 910 is a non-volatile (persistent) storage device 908, such as a magnetic disk, optical disk, or flash card, for storing information, including instructions, which persists even when the computer system 900 is turned off or otherwise loses power.

Information, including instructions for processing the sensor data 108A, is provided to the bus 910 for use by the processor from an external input device 912, such as a keyboard containing alphanumeric keys operated by a human user, or a sensor. A sensor detects conditions in its vicinity and transforms those detections into physical expressions compatible with the measurable phenomenon used to represent information in computer system 900. Other external devices coupled to bus 910, used primarily for interacting with humans, include a display device 914, such as a cathode ray tube (CRT) or a liquid crystal display (LCD), or plasma screen or printer for presenting text or images, and a pointing device 916, such as a mouse or a trackball or cursor direction keys, or motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914, and pointing device 916 is omitted.

In the illustrated embodiment, special-purpose hardware, such as an application specific integrated circuit (ASIC) 918, is coupled to the bus 910. The special purpose hardware is configured to perform operations not performed by processor 902 quickly enough for special purposes. Examples of application specific ICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

The computer system 900 also includes one or more instances of a communications interface 920 coupled to bus 910. The communication interface 920 provides a one-way or two-way communication coupling to a variety of external devices that operate with their own processors, such as printers, scanners, and external disks. In general, the coupling is with a network link 922 that is connected to a local network 924 to which a variety of external devices with their own processors are connected. For example, the communication interface 920 may be a parallel port or a serial port or a universal serial bus (USB) port on a personal computer. In some embodiments, communications interface 920 is an integrated services digital network (ISDN) card or a digital subscriber line (DSL) card or a telephone modem that provides an information communication connection to a corresponding type of telephone line. In some embodiments, the communication interface 920 is a cable modem that converts signals on the bus 910 into signals for a communication connection over a coaxial cable or into optical signals for a communication connection over a fiber optic cable. As another example, communications interface 920 may be a local area network (LAN) card to provide a data communication connection to a compatible LAN, such as Ethernet. Wireless links may also be implemented. For wireless links, the communications interface 920 sends or receives or both sends and receives electrical, acoustic, or electromagnetic signals, including infrared and optical signals, which carry information streams, such as digital data. For example, in wireless handheld devices, such as mobile telephones like cell phones, the communications interface 920 includes a radio band electromagnetic transmitter and receiver called a radio transceiver. In certain embodiments, the communications interface 920 enables connection to the communication network 120 for processing the sensor data 108A.

The term computer-readable medium is used herein to refer to any medium that participates in providing information to processor 902, including instructions for execution. Such a medium may take many forms, including, but not limited to, non-volatile media, volatile media, and transmission media. Non-volatile media include, for example, optical or magnetic disks, such as storage device 908. Volatile media include, for example, dynamic memory 904. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization, or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 922 typically provides information communication using transmission media through one or more networks to other devices that use or process the information. For example, the network link 922 may provide a connection through local network 924 to a host computer 926 or to equipment 928 operated by an Internet Service Provider (ISP). ISP equipment 928 in turn provides data communication services through the public, worldwide packet-switching communication network of networks now commonly referred to as the Internet 930.

A computer called a server 932 connected to the Internet hosts a process that provides a service in response to information received over the Internet. For example, server 932 hosts a process that provides information representing video data for presentation at display 914. It is contemplated that the components of the system can be deployed in various configurations within other computer systems, e.g., host 926 and server 932.

FIG. 10 is a diagram of a chip set 1000 that can be used to implement an embodiment. The chip set 1000 is programmed to process the sensor data 108A as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1000 includes a communication mechanism such as a bus 1002 for passing information among the components of the chip set 1000. A processor 1004 has connectivity to the bus 1002 to execute instructions and process information stored in, for example, a memory 1006. The processor 1004 may include one or more processing cores with each core configured to perform independently. A multi-core processor enables multiprocessing within a single physical package. Examples of a multi-core processor include two, four, eight, or greater numbers of processing cores. Alternatively, or in addition, the processor 1004 may include one or more microprocessors configured in tandem via the bus 1002 to enable independent execution of instructions, pipelining, and multithreading. The processor 1004 may also be accompanied with one or more specialized components to perform certain processing functions and tasks such as one or more digital signal processors (DSP) 1008, or one or more application-specific integrated circuits (ASIC) 1010. A DSP 1008 typically is configured to process real-world signals (e.g., sound) in real time independently of the processor 1004. Similarly, an ASIC 1010 can be configured to perform specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1004 and accompanying components have connectivity to the memory 1006 via the bus 1002. The memory 1006 includes both dynamic memory (e.g., RAM, magnetic disk, writable optical disk, etc.) and static memory (e.g., ROM, CD-ROM, etc.) for storing executable instructions that when executed perform the inventive steps described herein to process the sensor data 108A. The memory 1006 also stores the data associated with or generated by the execution of the inventive steps.

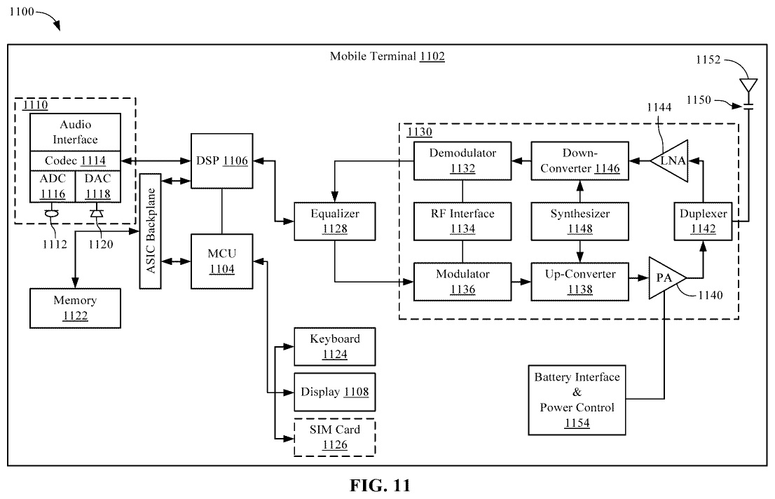

FIG. 11 is a diagram of a mobile terminal 1102 (e.g., handset, vehicle, or part thereof) that can be used to implement an embodiment. Generally, a radio receiver is often defined in terms of front-end and back-end characteristics. The front end of the receiver encompasses all of the Radio Frequency (RF) circuitry whereas the back end encompasses all of the base-band processing circuitry. Pertinent internal components of the telephone include a Main Control Unit (MCU) 1104, a Digital Signal Processor (DSP) 1108, and a receiver/transmitter unit including a microphone gain control unit and a speaker gain control unit. A main display unit 1106 provides a display to the user in support of various applications and mobile station functions that offer automatic contact matching. An audio function circuitry 1110 includes a microphone 1112 and microphone amplifier that amplifies the speech signal output from the microphone 1112. The amplified speech signal output from the microphone 1112 is fed to a coder/decoder (CODEC) 1114.

A radio section 1130 amplifies power and converts frequency in order to communicate with a base station, which is included in a mobile communication system, via antenna 1152. The power amplifier (PA) 1140 and the transmitter/modulation circuitry are operationally responsive to the MCU 1104, with an output from the PA 1140 coupled to the duplexer 1142 or circulator or antenna switch, as known in the art. The PA 1140 also couples to a battery interface and power control unit 054.

In use, a user of mobile station 1102 speaks into the microphone 1112 and his or her voice along with any detected background noise is converted into an analog voltage. The analog voltage is then converted into a digital signal through the Analog to Digital Converter (ADC) 1116. The control unit 1104 routes the digital signal into the DSP 1108 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, 5G New Radio networks, code division multiple access (CDMA), wireless fidelity (Wi-Fi), satellite, and the like.

The encoded signals are then routed to an equalizer 1128 for compensation of any frequency-dependent impairments that occur during transmission though the air such as phase and amplitude distortion. After equalizing the bit stream, the modulator 1136 combines the signal with an RF signal generated in the RF interface 1134. The modulator 1136 generates a sine wave by way of frequency or phase modulation. In order to prepare the signal for transmission, an up-converter 1138 combines the sine wave output from the modulator 1136 with another sine wave generated by a synthesizer 1148 to achieve the desired frequency of transmission. The signal is then sent through a PA 1140 to increase the signal to an appropriate power level. In practical systems, the PA 1140 acts as a variable gain amplifier whose gain is controlled by the DSP 1108 from information received from a network base station. The signal is then filtered within the duplexer 1142 and optionally sent to an antenna coupler 1150 to match impedances to provide maximum power transfer. Finally, the signal is transmitted via antenna 1152 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1102 are received via antenna 1152 and immediately amplified by a low noise amplifier (LNA) 1144. A down-converter 1146 lowers the carrier frequency while the demodulator 1132 strips away the RF leaving only a digital bit stream. The signal then goes through the equalizer 1128 and is processed by the DSP 1108. A Digital to Analog Converter (DAC) 1118 converts the signal and the resulting output is transmitted to the user through the speaker 1120, all under control of a Main Control Unit (MCU) 1104 which can be implemented as a Central Processing Unit (CPU) (not shown).

The MCU 1104 receives various signals including input signals from the keyboard 1124. The keyboard 1124 and/or the MCU 1104 in combination with other user input components (e.g., the microphone 1112) comprise a user interface circuitry for managing user input. The MCU 1104 runs a user interface software to facilitate user control of at least some functions of the mobile station 1102 for processing the sensor data 108A. The MCU 1104 also delivers a display command and a switch command to the display 1106 and to the speech output switch controller, respectively. Further, the MCU 1104 exchanges information with the DSP 1108 and can access an optionally incorporated SIM card 1126 and a memory 1122. In addition, the MCU 1104 executes various control functions required of the station. The DSP 1108 may, depending upon the implementation, perform any of a variety of conventional digital processing functions on the voice signals. Additionally, DSP 1108 determines the background noise level of the local environment from the signals detected by microphone 1112 and sets the gain of microphone 1112 to a level selected to compensate for the natural tendency of the user of the mobile station 1102.

The CODEC 1114 includes the ADC 1116 and DAC 1118. The memory 1122 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1122 may be, but not limited to, a single memory, CD, DVD, ROM, RAM, EEPROM, optical storage, or any other non-volatile or non-transitory storage medium capable of storing digital data.

An optionally incorporated SIM card 1126 carries, for instance, important information, such as the cellular phone number, the carrier supplying service, subscription details, and security information. The SIM card 1126 serves primarily to identify the mobile station 1102 on a radio network. The card 1126 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
obtaining, from at least one sensor, first smoking event data associated with a first smoking event on a first road link, wherein the first smoking event is associated with usage of at least one smoking product by a first user on the first road link;
retrieving a first set of features comprising:
i) road link properties of the first road link, and
ii) context information associated with the first smoking event on the first road link;
training a machine learning (ML) model using the retrieved first set of features to determine an association between the retrieved first set of features and the first smoking event; and
storing the trained ML model.

2. The method of claim 1, wherein the ML model is trained to provide a first probability score associated with the usage of the at least one smoking product by the first user based at least on the determined association between the first set of features and the first smoking event.

3. The method of claim 1, wherein the first user is traveling on the first road link on a vehicle associated with a user device.

4. The method of claim 1, wherein the first road link is determined by map matching a location of the first smoking event data associated with the first smoking event, and wherein the road link properties of the first road link are retrieved from a geographic map database.

5. The method of claim 1, wherein the context information of the first set of features comprises at least one of: emotional state information associated with the first user, a first user profile associated with the first user, traffic information, weather information, visibility information, occupancy information, air quality information, route information, and waiting event information.

6. The method of claim 1, wherein the at least one smoking product corresponds to: a cigarette, a cigar, a pipe tobacco, an electronic cigarette, a vape, a pod, an herbal cigarette, or a water pipe.

7. The method of claim 1, wherein the at least one sensor comprises at least one of: a smoke detector, an image capture device, an audio capture device, an infrared sensor, or a combination thereof.

8. The method of claim 7, wherein obtaining the first smoking event data further comprises:
detecting a behavior pattern based on sensor data collected from the at least one sensor, wherein the behavior pattern is associated with a smoking activity.

9. The method of claim 7, further comprising:
determining a smoking product ignition pattern associated with the first user based on the first smoking event data; and
training the ML model based on the determined smoking product ignition pattern.

10. The method of claim 1, further comprising:
obtaining, from the at least one sensor, second smoking event data associated with a second smoking event on a second road link, wherein the second smoking event is associated with the usage of at least one smoking product by the first user on the second road link;
retrieving a second set of features comprising:
i) road link properties of the second road link, and
ii) context information associated with the second smoking event on the second road link; and
update the trained ML model using the retrieved second set of features to determine the association between the retrieved second set of features and the second smoking event.

11. The method of claim 1, further comprising:
retrieving a third set of features comprising:
i) road link properties of a third road link, and
ii) context information associated with a third smoking event on the third road link;
providing, as an input, the retrieved third set of features to the trained ML model; and
predicting a third probability score associated with the usage of the at least one smoking product by the first user on the third road link based on an output of the ML model.

12. A system comprising:
at least one processor; and
at least one memory including computer program code for one or more programs, and a machine learning (ML) model trained on a first set of features associated with at least a first road link to predict a first probability score associated with usage of at least one smoking product by a first user on the first road link;
the at least one memory and the computer program code configured to, with the at least one processor, cause the system to perform at least the following:
retrieve a second set of features comprising:
i) road link properties of a second road link, and
ii) context information associated with a second smoking event on the second road link; wherein the first user is expected to travel on a first route comprising the second road link;
provide, as an input, the retrieved second set of features to the ML model;
predict a second probability score associated with the usage of the at least one smoking product by the first user on the second road link based on an output of the ML model;
compare the second probability score with a pre-determined threshold probability score;
determine, based on the comparison, a second route comprising at least a third road link of a set of road links, wherein a destination of the second route is same as the destination of the first route, and wherein a third probability score associated with the usage of the at least one smoking product by the first user on the third road link is less than at least one of the pre-determined threshold probability score or the second probability score; and
provide the determined second route for navigation via a user device associated with the first user.

13. The system of claim 12, wherein the context information of the second set of features comprises at least one of: emotional state information associated with the first user, a first user profile associated with the first user, traffic information, weather information, air quality information, visibility information, occupancy information, route information, and waiting event information.

14. The system of claim 12, wherein the system is further caused to:
determine, based on the comparison, the set of road links with a source and the destination of the each of the set of road links are same as the source and the destination of the second road link;
predict a probability score associated with the usage of the at least one smoking product by the first user on each of the set of road links, wherein the probability score is predicted based on an output of the ML model;
assign a score to each of the set of road links based on the probability score associated with the corresponding road link and the pre-determined threshold probability score; and
determine the second route comprising at least one of the third road link of the set of road links based on the assigned score.

15. The system of claim 12, wherein the system is further caused to:
monitor the first user traveling on the third road link on a vehicle associated with a user device for the usage of the at least one smoking product based on sensor data captured by at least one sensor, wherein the at least one sensor is associated with the user device.

16. The system of claim 15, wherein the system is further caused to:
retrieve a third set of features comprising:
i) road link properties of the third road link; and
ii) context information associated with the at least one smoking event on the third road link; and
train the ML model using the retrieved third set of features.

17. The system of claim 12, wherein the at least one smoking product corresponds to: a cigarette, a cigar, a pipe tobacco, an electronic cigarette, a vape, a pod, an herbal cigarette, or a water pipe.

18. A non-transitory computer-readable medium having stored thereon, computer-executable instructions that when executed by a processor of a system, causes the processor to execute operations, the operations comprising:
retrieving a second set of features comprising:
i) road link properties of a second road link, and
ii) context information associated with a second smoking event on the second road link;
providing, as an input, the retrieved second set of features to a machine learning (ML) model, wherein the ML model is trained on a first set of features associated with at least a first road link to predict a first probability score associated with usage of at least one smoking product by a first user on the first road link;
predicting a second probability score associated with the usage of the at least one smoking product by the first user on the second road link based on an output of the ML model;
comparing the second probability score with a pre-determined threshold probability score;
generating an output based on the comparison of the second probability score with the pre-determined threshold probability score; and
rendering the generated output.

19. The non-transitory computer-readable medium of claim 18, further comprising:
generating, as the output, at least one of: an audio message or a visual message associated with the usage of at least one smoking product; and
rendering the generated output.

20. The non-transitory computer-readable medium of claim 18, further comprising:
generating, as the output, a warning message associated with the usage of the at least one smoking product by one or more users on the second road link; and
rendering the generated output.
